(19) United States
(12) Patent Application Publication
(10) Pub. No.: US 2025/0026510 A1
(43) Pub. Date: Jan. 23, 2025

(54) MACHINE FOR THE PRODUCTION OF DISPOSABLE PACKAGES OF PRODUCTS, PARTICULARLY OF GROUND OR POWDERY PRODUCTS

(71) Applicant: COMPOPACK S.R.L., Medicina (IT)

(72) Inventors: Stephen Christopher Lowe, Medicina (IT); Roberto Verri, Medicina (IT); Ambros Venturi, San Lazzaro di Savena (IT)

(21) Appl. No.: 18/708,635

(22) PCT Filed: Nov. 8, 2022
(86) PCT No.: PCT/IB2022/060741

§ 371 Date: May 9, 2024

(30) Foreign Application Priority Data
Nov. 9, 2021 (IT) 102021000028484

(51) Int. Cl. B65B 1/24; B65B 1/06; B65B 37/02

(52) U.S. Cl. CPC B65B 1/24; B65B 1/06; B65B 37/02

(57) ABSTRACT

A machine (100) is shown that produces disposable packages, for example pods (K) of ground or powder products (P) to be brewed, defined by two coupled half-shells, a bottom half-shell (C) and an upper half-shell (C2) respectively, made of composite material. The machine (100) includes a closed loop track (2), made in the upper surface (1S) of a board (1); a plurality of blocks (3), arranged one against the other to fill the closed loop track (2); advancing means (4), provided for moving stepwise the blocks (3), each of which is provided with a size adapted imprint (30).

### TECHNICAL FIELD

The present invention relates to the technical field of automatic machines for packaging products, in particular ground or powder, but also liquid, granular or creamy products.

### BACKGROUND ART

The indicated technical field is extremely broad and includes all kinds of products from food to pharmaceuticals, from cosmetics to chemicals, and a considerable number of types of rigid, semi-rigid and soft containers, into which said products can be introduced.

The present invention refers, more selectively, to machines suitable for producing disposable packages which use tumbler, jar, capsule, pod or similar containers, into each of which an amount of one of said liquid, creamy, granular, ground or powder products is introduced.

The products under consideration, in the just specified forms, are preferably food related, although the invention is also valid for products of any other type having the same liquid, creamy, granular, ground or powder forms.

Generally speaking, any known automatic machine handling the above mentioned containers and products includes a conveyor line conformed in such a way as to receive, hold and move forward a row of said containers, which are open at the top, so that the intended amount of product can be introduced therein, in a filling station situated along said conveyor line.

In a subsequent downstream station, the filled containers are then closed by a cover, or similar, e.g. a cap or sealing film, and then made ready to be sent to next processing stages.

### Technical Problem

A first drawback that often afflicts the above-mentioned machines derives from their poor adaptability to changes of container formats or their construction characteristics in terms of material and/or their greater or lesser rigidity. In practice, a machine designed and built for a specific type of container, together with the respective cover, does not have much margin to adapt to changes of the specific originally intended characteristics.

Known automatic machines are also quite difficult to adapt if the type of the product to be delivered changes substantially, for example from liquid to granular: also in this case, the machine construction system is “rigid”, which often makes it problematic to modify what was originally planned.

The changeable needs and demands that from the commercial sector are directed to the production sector and then to the companies that produce the automatic machines, are evidently in conflict with the above mentioned lack of adaptability granted by the known machines.

Obviously, going into details of what has just been said and into specific cases of various containers and/or types of products is not possible in this context, but what is meant is to highlight the technical problem intended to be solved by the present invention, changing the paradigm with which said machines are conceived, designed and built.

### Objects of the Invention

Therefore, it is an object of the present invention to propose an original machine for the production of disposable packages of products, wherein said packages are tumbler, jar, capsule, pod or similar containers, into which single amounts of one of said products, in liquid, creamy, granular, ground or powder form, are introduced, and which are subsequently closed by a cover, said machine being shaped in such a way as to be much more versatile than the machines of the prior art.

Another object of the invention is to propose a machine with a transport and advancement system for containers which goes beyond the usual construction standards and which, therefore, is able to adapt more easily to changes in the shape and/or material of said containers.

A still further object of the invention is to provide a very flexible machine layout, both in terms of the number and arrangement of the various operating stations, according to the various requirements, yet maintaining unchanged the construction concept of the above mentioned transport and advancement system for containers.

A further object of the invention is to produce a machine whose construction structure is as simple as possible and is not an obstacle if the machine has to be equipped with additional operating means performing specific functions, which may be required by the type of container and/or product.

Yet another object of the invention is to obtain a machine in which automation degree of the operation steps can be modulated during construction, also depending on the specific requests of the customer, as well as on the particularities of containers and products.

### SUMMARY OF THE INVENTION

These and other objects are fully achieved by means of a machine for the production of disposable packages of products, with said packages being tumbler, jar, capsule, pod or similar containers, into which amounts of one of said products, in liquid, creamy, granular, ground or powder form, are introduced, and which are subsequently closed by a cover.

The above mentioned machine comprises:
a supporting structure with a substantially horizontal board provided in its upper part;
at least one closed loop track made in the upper surface of said board;
a plurality of independent cylindrical blocks, arranged in a row, one against the other, and with a vertical axis, so as to fill said at least one closed loop track, with each of said blocks provided, in the respective upper horizontal surface, with a size adapted imprint, aimed at receiving at least partially and holding in a predetermined position one of said tumbler, jar, capsule, pod or similar containers;
advancing means, associated with said board and aimed at moving stepwise said blocks along said at least one track;
a first operating station, arranged along said at least one closed loop track and provided with first means for the singular supply of said containers and for their storage in said blocks;
a second operating station, situated downstream of the first operating station along said at least one track and provided with filling means aimed at introducing said amount of product in liquid, creamy, ground, granular or powder form into each of said containers supported by said blocks;
a third operating station, situated downstream of the second operating station along said at least one track and equipped with second means for supplying and applying said cover to each of the containers, filled with the respective amount of product;
a fourth operating station, situated downstream of the third operating station along said at least one track and provided with handling means aimed at withdrawing the finished packages from said blocks and at unloading said packages onto a transport line arranged next to said at least one track.

### BRIEF DESCRIPTION OF THE DRAWINGS

The characteristics of the invention will become obvious from the following description of a preferred embodiment of the machine for the production of disposable packages referred to above, in accordance with the content of the claims and with the help of the enclosed drawings, in which:

FIG. 1A is a schematic axonometric overall view of a preferred version of the proposed machine;

FIG. 1B is a view similar to FIG. 1A, with parts removed to better show others;

FIG. 2 is a plan view of the machine of the previous figures;

FIG. 3 is a longitudinal section of a portion of a track of the machine with cylindrical blocks being moved therealong;

FIG. 4 is a longitudinal section of another portion of the track in which centring means operate to engage one of said blocks from below;

FIG. 5 is an axonometric view one of said blocks and an exploded view of the lower and upper half-shells of a pod;

FIG. 6 is a schematic view of a first operating station, arranged along the track, in which the first supplying means are aimed at positioning one of said lower half-shells in a corresponding block;

FIG. 7 is a section view of a second operating station, arranged along the track downstream of the first operating station, in which filling means are aimed at introducing an amount of powder product into each lower half-shell carried by a respective block;

FIG. 8 is a schematic view of a third operating station, arranged along the track downstream of the second operating station, in which second supplying means are aimed at placing upper half-shells on the corresponding lower half-shells and amounts of product;

FIG. 9 is a section view of pressing means provided in the third operating station, downstream of the above-mentioned second supplying means, aimed at compacting the amount of product;

FIG. 10 is a section view of welding means provided in the third operating station, downstream of the above-mentioned pressing means, aimed at joining the annular edges of the two half-shells in order to form a pod;

FIG. 11 is a section view of trimming means provided in the third operating station, downstream of the above mentioned welding means, aimed at cutting to size the annular edge of the pods.

### DESCRIPTION OF PREFERRED EMBODIMENTS OF THE INVENTION

In the above listed figures, the reference numeral 100 indicates the machine, as a whole, for the production of disposable packages of products proposed by the present invention.

By virtue of its characteristics which will be described below, the machine 100 can be easily prepared to operate with packages K comprising tumbler, jar, capsule, pod or similar containers C, into which amounts of a product P are introduced, by way of non-limiting example, of food type, in liquid, creamy, granular, ground or powder form.

In the machine 100, a closing and sealing cover C2 is subsequently applied to the container C to finish the package K.

In a basic configuration, the machine 100 comprises a supporting structure (not illustrated in detail) with a substantially horizontal board 1 provided in the upper surface thereof.

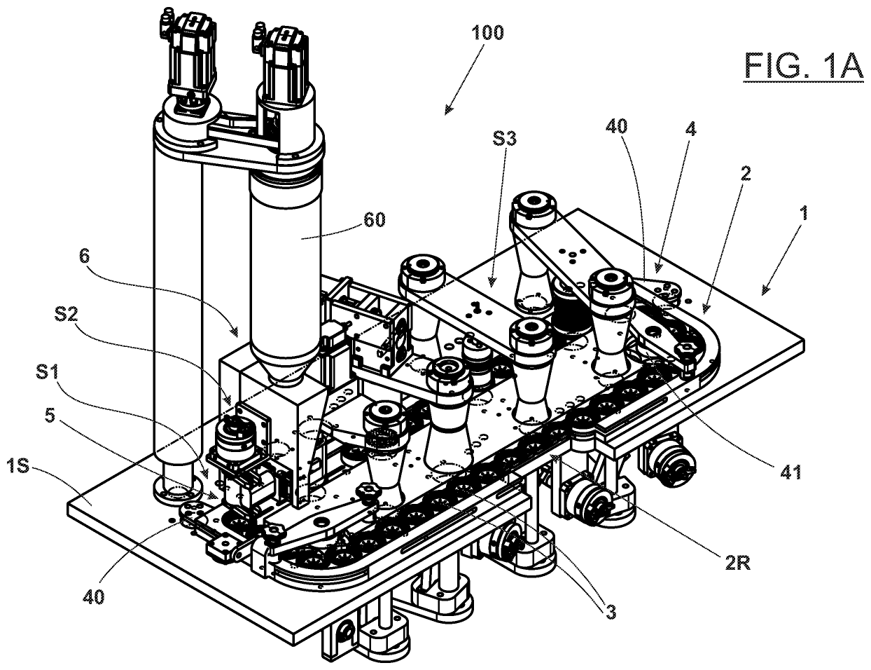

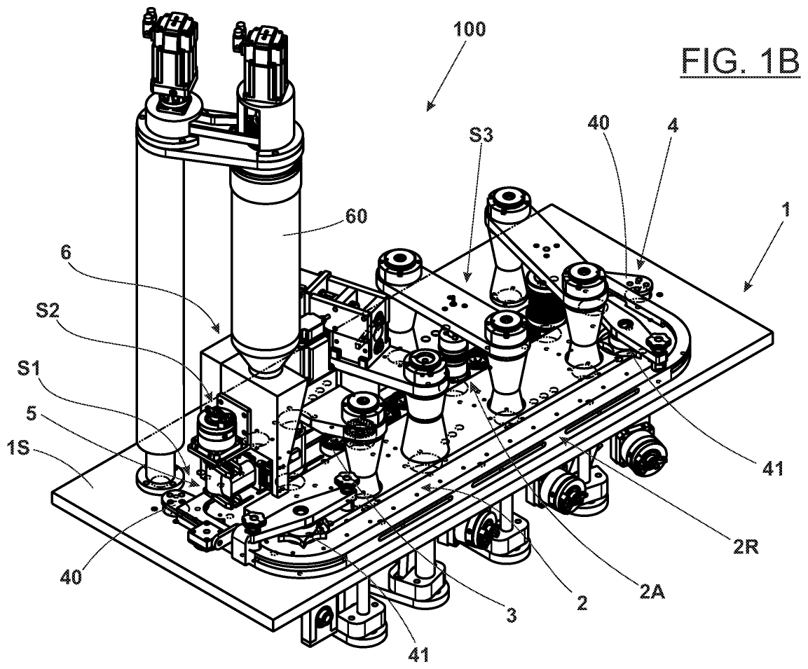

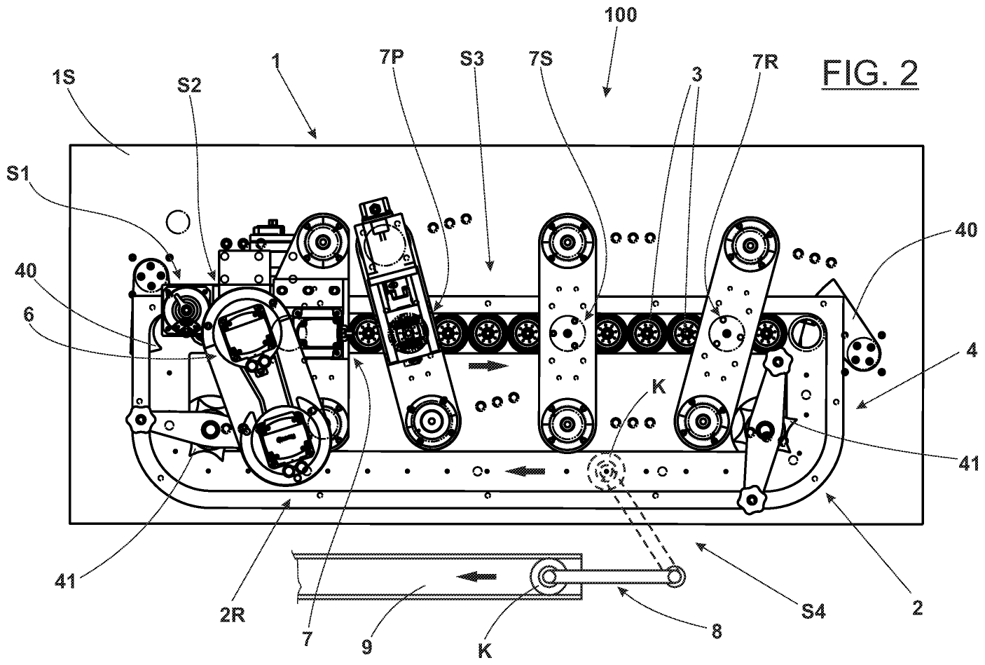

In the upper surface 1S of the board 1, at least one closed loop track 2 is provided, for example of an almost rectangular shape, comprising a forward section 2A, preferably rectilinear, along which the various operating stations, which will be discussed below, and the remaining return sections 2R are situated in succession (FIGS. 1A, 1B, 2).

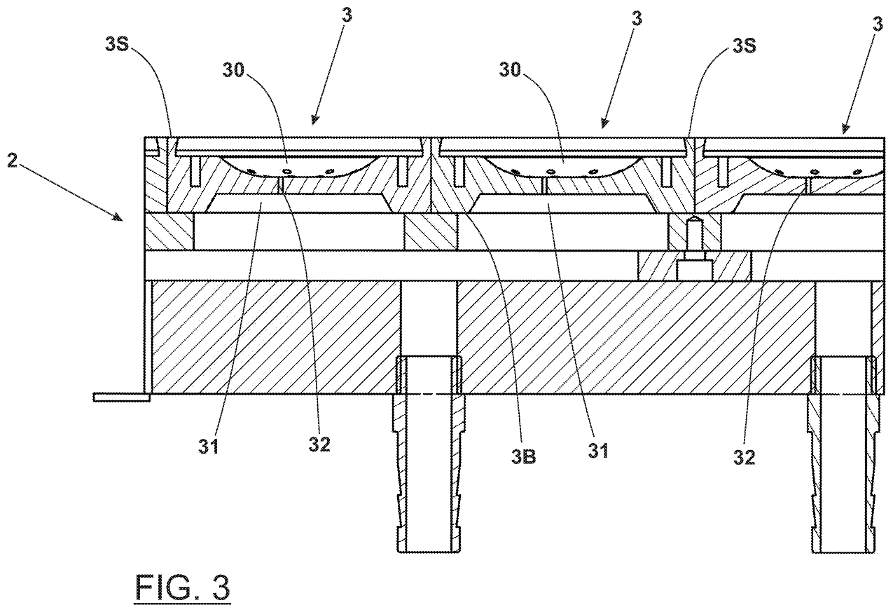

The track 2 is completely filled with a plurality of independent blocks 3 of cylindrical shape, arranged in a row one against another and with a vertical axis. It is obvious that in order to fully respect the filling condition, if it is necessary that the length of the track 2 along its mean axis is a multiple of the diameter of said blocks 3 (FIGS. 1A, 3).

Each of the blocks 3 is provided, in its upper horizontal surface, with a size adapted imprint, aimed at receiving at least partially and holding in a predetermined position one of said tumbler, jar, capsule, pod or similar containers.

The blocks 3 are moved stepwise along said track 2 by advancing means 4, associated with said board 1 and comprising, in the illustrated example, two pushers 40 positioned at the beginning and at the end of said forward section 2A, and a pair of rotary star conveyors 41, along said return sections 2R (FIGS. 1A, 1B, 2).

The number of the pushers 40 and/or rotary star conveyors 41 may vary depending on the layout of the track 2, but in any case, their actuation is synchronised for each forward movement step imposed to the row of blocks 3.

As already mentioned, operating stations are located in succession along the forward section 2A of the track 2, including for example:
a first operating station S1, equipped with first means 5 for the singular supply of said containers C and for their storage in corresponding blocks 3;
a second operating station S2, situated downstream of the first operating station S1 and provided with filling means 6 aimed at introducing said amount of product in liquid, creamy, ground, granular or powder form into each of said containers C supported by respective blocks 3;
a third operating station S3, situated downstream of the second operating station S2 and equipped with second means 7 for supplying and applying said cover C2 to each of the containers C, filled with the respective amount of product P, to finish the above mentioned packages K.

A fourth operating station S4, situated downstream of the third station S3, along the same forward section 2A, or at any point of said return sections 2R, is provided with handling means 8 aimed at withdrawing the finished packages K from the blocks 3 and at unloading the packages K onto a conveying line 9 arranged alongside said track 2 (see in particular FIG. 2).

The machine 100, briefly described above, has been illustrated in a preferred version, suitable for the production of packages K comprising single pods of ground or powder brewing products P, by way of non-limiting example, coffee or the like.

In particular, the pods K are defined by two coupled half-shells of composite material, respectively a lower half-shell C and an upper half-shell C2 (FIG. 5), successively joined at respective mutually overlapping annular edges B, B2.

It should be noted that the above-mentioned composite material is not permeable to water, so it is not the usual filter paper, and the so obtained pods K are intended for coffee machines with needles aimed at piercing the pod K, before boiling water is supplied.

In this version of the machine 100, said blocks 3 have the respective dome-like imprint 30, suitable for receiving the above mentioned lower half-shell C.

In said first operating station S1, the aforementioned first supplying means 5 are aimed at releasing the lower half-shells C one by one and placing them, in a predetermined orientation, in the imprints 30 of said blocks 3, in phase relation with the stepwise forward movement imposed to said blocks 3.

The first supplying means 5 have been illustrated schematically, as their conformation is not relevant for the scope of the present invention and depends on technical choices which may be different with the same final result in terms of the performed manipulation.

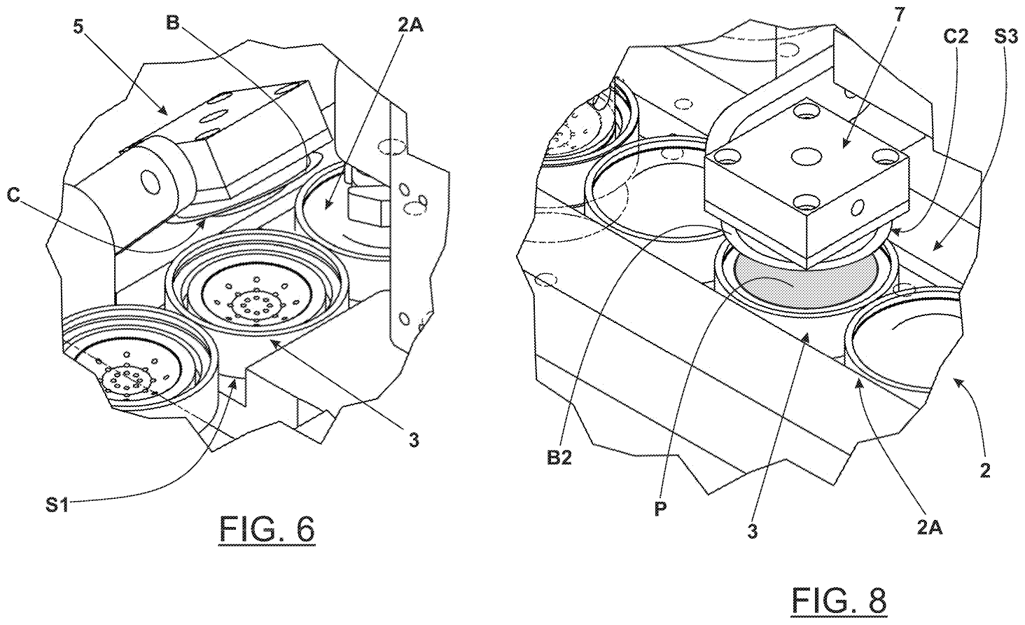

As a rule, the lower half-shells C are produced out of line and, for example, can be fed to the first operating station S1 one by one by suitable first supplying means 5 comprising suitable means for placing them in the imprint 30 of the blocks 3 (FIG. 6).

An alternative embodiment, not illustrated but easily understood by those skilled in the art, can provide first supplying means 5, comprising a magazine, for example a silo, in which said lower half-shells C are stored in a stack, and handling means, for example a pick and place machine, which picks said lower half-shells C one by one from the magazine and then places them in the imprint 30.

In said second operating station S2, in the example, the conformation of the above mentioned filling means 6 is suitable for measuring and releasing a ground brewing product P, comprising coffee.

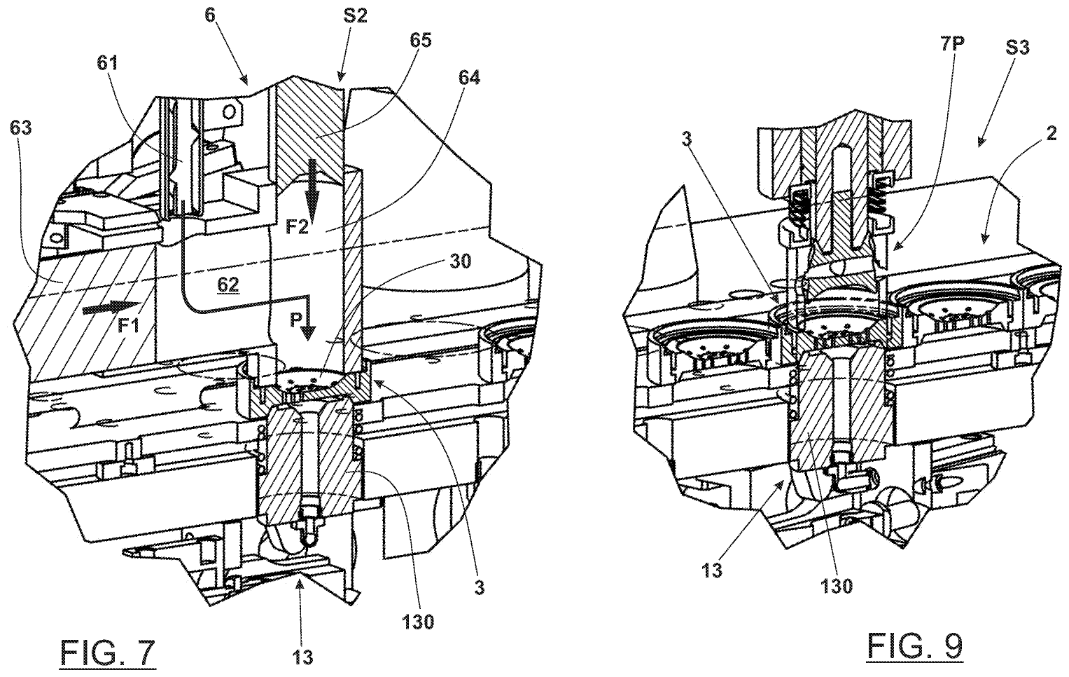

In the non limiting example of FIG. 7, said filling means 6 comprise a column silo 60, in which the ground or powder product P for brewing is stored.

At the base of said column silo 60 there is an outlet channel 61 controlled by measuring means (not illustrated) which releases, due to gravity, the intended amount of ground or powder brewing product P; for greater clarity, the subsequent path of the product P has been graphically represented with an arrow in FIG. 7.

The product P enters an underlying chamber 62 in which a horizontally moving plunger 63 acts horizontally (Arrow F1) to transfer said amount of product P into a cylindrical collecting cavity 64 below which the corresponding block 3 with its respective lower half-shell C is dwelling in coaxial relationship therewith.

Compacting means 65, integrated with the aforementioned filling means 6, are aimed at pressing the amount of coffee inserted into each lower half-shell C, and at shaping the upper part thereof, protruding from the lower half-shell C.

Still in FIG. 7, the compacting means 65 comprise a punch, sliding vertically in said cylindrical collecting cavity 64 and operated in a downward phase relation (Arrow F2), to contact the product P and push it under pressure into the lower half-shell C.

In the third operating station S3, the aforementioned second supplying means 7 are aimed at releasing said upper half-shells C2 one by one and at placing them like covers on the corresponding lower half-shells C and on the corresponding doses of coffee P, or similar brewing product, compacted and shaped, with inverted orientation with respect to said lower half-shells C.

Similarly to what has already been said above with reference to the first supplying means 5, the second supplying means 7 have also been illustrated schematically, as not critical for the purposes of the present invention, for example, having a shape similar to that of the first supplying means (FIG. 8).

The upper half-shells C2 are also produced out of line, and the possible constructive versions for said second supplying means 7 resemble those mentioned above with regard to the first supplying means 5.

In the third operating station S3, pressing means 7P, provided downstream of the aforementioned second supplying and positioning means 7 of the upper half-shells C2, are intended to assure that the upper half-shells adhere perfectly to the product P thereinside (FIG. 9).

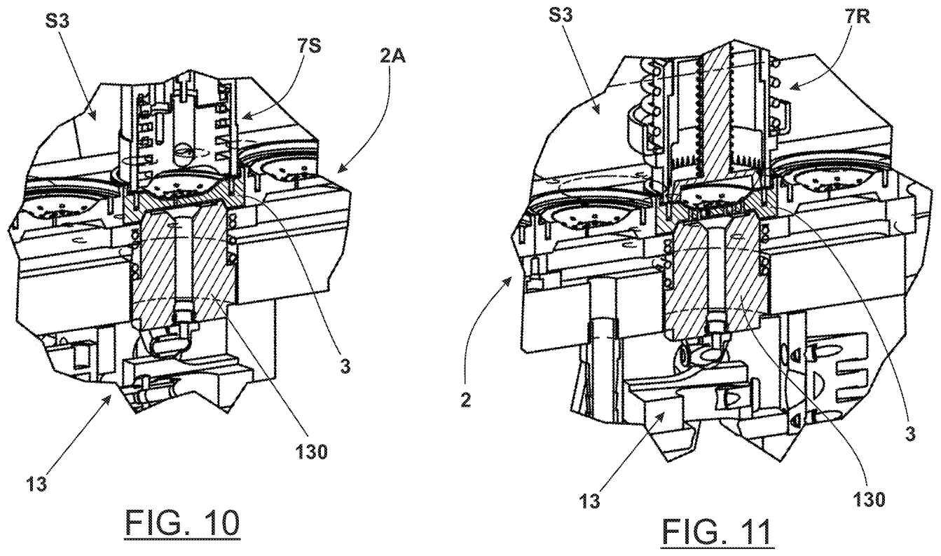

Welding means 7S, provided downstream of said pressing means 7P, in the same third operating station S3, are intended to permanently join the annular edges B, B2 of said lower half-shells C and upper half-shells C2, in order to define a corresponding pod K (FIG. 10).

The aforementioned welding means 7S can be thermal or ultrasonic welding means.

If necessary, trimming means 7R are provided in the third operating station S3 and are intended to cut to size the margin of the annular edge of the said pods K.

In a preferred constructive solution, said trimming means 7R are arranged downstream of said welding means 7S (FIG. 11).

However, in a possible version, the trimming means 7R are in one group with the aforementioned welding means 7S.

Said pressing means 7P, welding means 7S and trimming means 7R are not described in detail, as their components and operation are known to those skilled in the art and are intuitively understood by examining the respective figures.

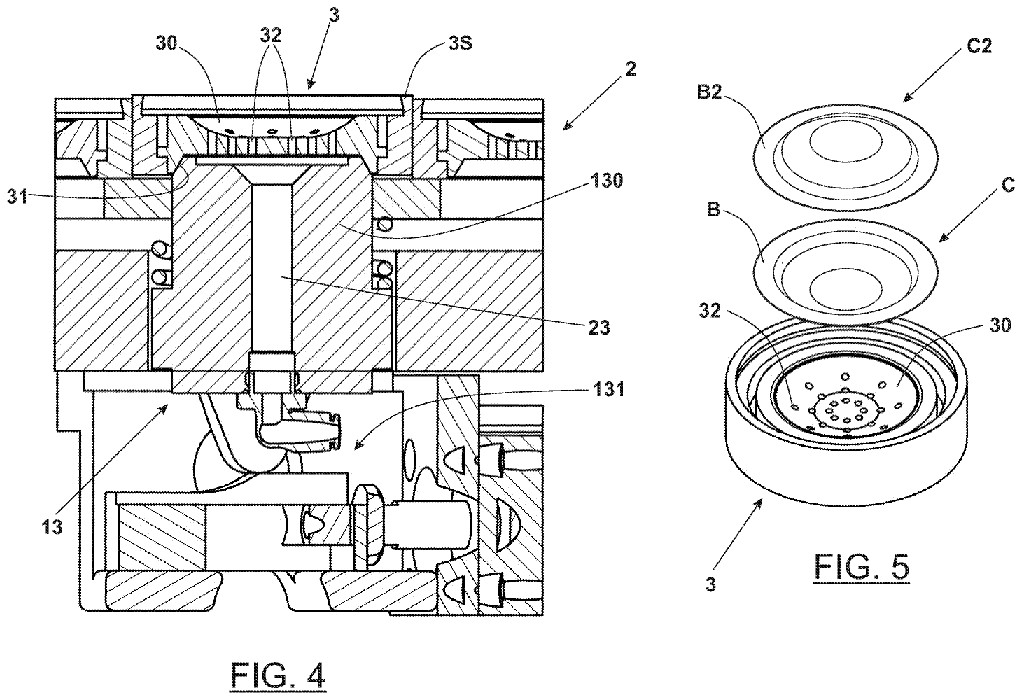

The machine 100, either in the described general basic configuration or in any other version specifically arranged for the different types of packages K and/or products P, including the preferred version illustrated and described above, may advantageously comprise a truncated conical seat 31 made in the lower horizontal surface 3B of each of the aforementioned blocks 3 and intended to couple with centring means 13 provided in at least one of said operating stations (see in particular FIG. 4).

The centring means 13 are arranged below said track 2 and comprise a vertical stem 130 having a truncated conical head and actuated for example by a cam mechanism 131 controlled by an actuator.

The vertical stem 130 is lifted in phase relation with the stay of said blocks 3, through a corresponding opening at the bottom of said track 2, in order to couple with said truncated-conical seat 31 and thereby centre and slightly lift the same block 3 and the attached container C, so as to bring them to a predetermined position with fixed centring and height.

Preferably, these centring means 13 are provided at least in the aforementioned operating stations S2 and S3, as seen in FIGS. 7, 9, 10, 11.

In addition, again in any version of the machine 100, said blocks 3 may advantageously have through holes 32 made from the bottom of the respective imprint 30 towards the lower horizontal surface 3B of the same block B.

The imprint 30 can be put in communication, by means of said through-holes 32, with underlying vacuum generating means (not illustrated as known) aimed at acting in at least one of said operating stations S1, S2, S3, or along the entire length of the aforementioned forward section 2A of the track 2; in this way, a vacuum is created in the imprint 30, stabilising, by suction, the position of the corresponding container C (or package K, if already finished) with respect to said block 3.

In operating stations in which the aforementioned centring means 13, with the vertical stem 130, are provided together with said vacuum generating means, the above mentioned vertical stem 130 is advantageously provided with at least one through channel 23, longitudinal thereto, intended to connect said through holes 32 made in the bottom of the aforementioned blocks 3 with the underlying vacuum generating means.

An interesting version of the machine 100, not illustrated, is proposed in order to increase its productivity.

In said version the forward section 2A of the closed loop track 2, which extends through the aforementioned operating stations S1, S2, S3 and any others, is composed of at least two separate lanes, having the same overall length, along each of which the respective blocks 3 move, fed upstream of the operating stations, moved therethrough and deviated downstream of said forward section 2A in a synchronised manner between the blocks 3 of each lanes.

As can be intuitively understood, all the means provided in each of said operating stations are replicated so as to operate simultaneously on the corresponding blocks 3 of both lanes.

A careful design makes it possible to said forward section 2A to have more than two separate lanes, always respecting the condition of equal overall length, which implies an equal quantity of blocks 3 provided in each of the lanes.

The peculiar characteristics of the machine proposed by the invention emerge clearly from the foregoing description. The original conformation of the machine, out of the conventional schemes in particular with respect to the handling of the packages through the various operating stations, makes it very suitable for the production of disposable packages for product, where said packages are tumbler, jar, capsule, pod or similar containers, which are effectively supported by the blocks and always maintained in the correct position, even if the container itself is made of a yielding material and therefore its geometry is unstable.

In fact, the size adapted blocks, which are the core of the container transport system, absorb the stresses caused by the forward thrusts along the track, so that the containers remain unaffected by any abnormal deformation and/or breakage events, which cause malfunctions in known machines.

Furthermore, another particularly advantageous aspect to highlight is the fact that by keeping the external diameter of the blocks unchanged, it is possible to vary the shape and dimensions of the size adapted imprint to adapt it to a different container, obviously within the limits allowed by the external diameter, without compromising machine operation; in other words, by simply replacing the set of blocks on the track, which are only placed thereon, it is possible to change the format which in the prior art is either impossible or requires days of machine downtime due to the numerous adaptation operations required.

The machine works in the most effective way, obviously with the support of suitable operating elements, regardless of whether the amount of the product to be introduced into the containers is in liquid, creamy, granular, ground or powder form.

As it can be easily understood, by varying the path of the track, it is possible to obtain the preferred machine layout, depending on the number and arrangement of the various operating stations, as well as on the space required by each of the stations along the track.

The board on which the track is built is advantageous both because it has a simple supporting structure and because it allows to fix the various operating parts of the stations with maximum freedom, above or below the board.

In addition, it will be still possible to subsequently modify the arrangement of the operating means, in case the machine should be equipped with additional means for specific functions.

The proposed machine is also endowed with extreme flexibility in terms of the degree of automation to be given to the various operation steps, for example according to the customer's specific requests, even allowing, if necessary, the presence of an operator who will perform certain operations manually, without risks to his safety.

However, it is understood that what is described above is illustrative and not limiting, therefore any detail variations that may be necessary for technical and/or functional reasons are considered from now on within the same protection scope defined by the claims below.

1. A machine for the production of disposable packages of products, said packages (K) comprising a container (C), in particular a tumbler, jar, capsule or pod container, into which an amount of one of said products (P), in liquid, creamy, granular, ground or powder form, is to be introduced, said container being subsequently closed by a cover (C2), said machine (100) comprising:
a supporting structure with a substantially horizontal board (1) provided in its upper part;
at least one closed-loop track (2) made in the upper surface (1) of said board (1);
a plurality of independent cylindrical blocks (2), arranged in a row, against one another, and with a vertical axis, so as to fill said at least one closed loop track (2), with each of said blocks (3) provided, in the respective upper horizontal surface (3S), with a size adapted imprint (30), aimed at receiving, at least partially, and holding in a predetermined position one of said tumbler, jar, capsule, waffle or similar containers;
advancing means (4), associated with said board (1) and aimed at moving stepwise said blocks (3) along said at least one track (2);
a first operating station (S1), arranged along said at least one closed loop track (2) and provided with first means (5) for the singular supply of said containers (C) and for their storage in said blocks (3);
a second operating station (S2), situated downstream of the first operating station (S1) along said at least one track (2) and equipped with filling means (6) aimed at introducing said amount of product (P) in liquid, creamy, ground, granular or powder form into each of said containers (C) supported by respective blocks (3);
a third operating station (S3), situated downstream of the second operating station (S2) along said at least one track (2) and equipped with second means (7) aimed at supplying and applying a said cover (C2) to each of said containers (C), filled with the respective amount of product (P); and
a fourth operating station (S4), situated downstream of the third operating station (S3) along said at least one track (2) and provided with handling means (8) aimed at withdrawing the finished packages (K) from said blocks (3) and at unloading said packages (K) onto a transport line (9) arranged next to said at least one track (2).

2. The machine according to claim 1, suitable for packages (K) comprising pods of ground or powder brewery products (P), said pods (K) being defined by two coupled half-shells of composite material, respectively a lower half-shell (C) and an upper half-shell (C2), joined at respective mutually overlapping annular edges (B, B2), said machine (100) being characterized in that: said blocks (3) have a relative imprint (30), aimed at receiving the lower half-shell (C) of said pods (K); in said first operating station (S1), said first supplying elements (5) are aimed at releasing said lower half-shells (C2) one by one and at placing them, with a predetermined orientation, in said imprint (30) of said blocks (3); said second operating station (S2) comprises compacting means (65), integrated with said filling means (6), intended to compress said amount of product (P) to be brewed and to shape said upper part thereof; in said third operating station (S3), said second supplying means (7) are aimed at releasing said upper half-shells (C2) one by one and at placing them like covers on the corresponding lower half-shells (C) and on said compacted and shaped amounts of product (P) to be brewed, with inverted orientation with respect to said lower half-shells (C); and in that welding means (7S), provided in said third operating station (S3), downstream of said second supplying and positioning means (7) of the upper half-shells (C2), are intended to firmly join the annular edges (B, B2) of said lower half-shells (C) and upper half-shells (C2), so as to define a corresponding pod (K).

3. The machine according to claim 1, wherein a truncated conical seat (31) is made in the lower horizontal surface (3B) of each of said blocks (3), with centring means (13) provided in at least one of said operating stations (S1, S2, S3), arranged below said at least one track (2) and comprising a vertical stem (130) with a truncated conical head, aimed at being lifted in phase relation to the stop of said blocks (3), through a corresponding opening in the bottom of said track (2), in order to engage said truncated cone seat (31) and thereby centre and slightly lift the block (3) and the attached container (C), so as to bring them to a predetermined position with fixed centring and height.

4. The machine according to claim 1, wherein said blocks (3) have through holes (32) made in the bottom of the respective imprint (30) and towards the lower horizontal surface (3B) of said block (3), and wherein vacuum generating means, provided in at least one of said operating stations (S1, S2, S3), are arranged below said at least one track (2) and intended to be in communication with said imprint (30) by means of said through-holes (32), so as to create therein a vacuum which stabilises, by suction, the position of the corresponding container (C) with respect to said block (3).

5. The machine according to claim 2, wherein said welding means (7S), provided in said third operating station (S3) for joining said annular edges (B, B2) of said lower half-shell (C) and upper half-shell (C2), are thermal welding means.

6. The machine according to claim 2, wherein said welding means (7S), provided in said third operating station (S3) for joining said annular edges (B, B2) of said lower half-shell (C) and upper half-shell (C2), are ultrasonic welding means.

7. The machine according to claim 2, wherein trimming means (7R), provided in said third operating station (S3), downstream of said second supplying and positioning means (7) for said upper half-shells (C2) and welding means (7S), are intended to cut to shape the margin of the annular edge of said pods (K).

8. The machine according to claim 7, wherein said trimming means (7R) are in one group with said welding means (7S).

9. The machine according to claim 3, wherein said vertical stem (130) with a truncated conical head, provided in said centering means (13), is provided with at least one through channel (23), longitudinal thereto, intended to connect said through holes (32) made in the bottom of said blocks (3) with said vacuum generating means, arranged below said at least one track (2).

10. The machine according to claim 1, wherein a forward section (2A) of said closed loop track (2), which extends through said operating stations (S1, S2, S3), comprises at least two separate lanes, having the same overall length, along each of which the respective blocks (3) move, fed upstream of said operating stations (S1, S2, S3) and moved therethrough and deviated downstream of said forward section (2A) in a synchronised manner between the blocks (3) of each lane, all the operating means provided in each of said operating stations (S1, S2, S3) being replicated so as to operate simultaneously on the corresponding blocks (3) of all said separate lanes.
